(19) United States
(12) Patent Application Publication
(10) Pub. No.: US 2026/0285513 A1
(43) Pub. Date: Sep. 24, 2026

(54) UNMANNED AERIAL VEHICLE SYSTEMS AND METHODS

(71) Applicant: Swiss Robotics and Advanced Technologies AG, Winterthur (CH)

(72) Inventors: Mina Samir Fekry Kamel, Winterthur (CH); Michail Striligkas, Winterthur (CH); Kevin Jeulink, Winterthur (CH); Matteo Robin Giger, Winterthur (CH)

(73) Assignee: Swiss Robotics and Advanced Technologies AG, Winterthur (CH)

(21) Appl. No.: 19/071,270

(22) Filed: Mar. 5, 2025

(51) Int. Cl. B64U 30/297; B64U 10/16; B64U 20/87; B64U 30/26; B64U 101/30

(52) U.S. Cl. CPC B64U 30/297; B64U 10/16; B64U 20/87; B64U 30/26; B64U 2101/30

(57) ABSTRACT

An unmanned aerial vehicle includes a primary shroud, a primary rotor mounted to the primary shroud and defining a rotor axis, a center body at least partially surrounding the primary shroud and defining a center axis, and a plurality of auxiliary rotors located distal to the center body. The primary shroud is rotatably coupled to the center body. The primary rotor and the primary shroud can be rotatable together between a first orientation with respect to the center body, wherein the rotor axis and the center axis are substantially parallel, and a second orientation with respect to the center body, wherein the rotor axis and the center axis are substantially perpendicular.

### FIELD

The present disclosure relates generally to vehicles and equipment that are specifically adapted for unmanned aeronautical use, and more specifically, to unmanned aerial vehicles.

### BACKGROUND

In various industries, it is desirable to continuously inspect and manage integrity of various types of apparatus and structures. However, certain structures are difficult to reach and/or are dangerous for an inspector to inspect them directly with their equipment, which can lead to time-consuming and/or costly inspections processes.

Unmanned aerial vehicle systems (“drones”) have been developed with cameras for photography of a facility or structure in which damage, deterioration, and defects of a facility or structure can be photographed by bringing a drone, which is an unmanned air vehicle, close to the facility or the structure. However, existing drones currently have limited capabilities performing physical tasks such as cleaning, reaching certain areas, contact-based inspection, and/or flying in close proximity/in contact with structures.

### SUMMARY

Various aspects of the subject matter described in this disclosure may be embodied in an unmanned aerial vehicle. The unmanned aerial vehicle can include a primary shroud, a primary rotor mounted to the primary shroud and defining a rotor axis, a center body at least partially surrounding the primary shroud and defining a center axis, a first auxiliary rotor located distal to the center body, and a second auxiliary rotor located distal to the center body. The primary shroud can be rotatably coupled to the center body.

In various aspects, the primary rotor and the primary shroud can be rotatable together between a first orientation with respect to the center body, wherein the rotor axis and the center axis are substantially parallel, and a second orientation with respect to the center body, wherein the rotor axis and the center axis are substantially perpendicular. The unmanned aerial vehicle can further include a first housing located at a first end of the center body and extending outward from the center body away from the center axis. The unmanned aerial vehicle can further include a second housing located at a second end of the center body, opposite the first end, and extending outward from the center body away from the center axis. The unmanned aerial vehicle can further include a third auxiliary rotor located distal to the center body. The unmanned aerial vehicle can further include a fourth auxiliary rotor located distal to the center body. The first auxiliary rotor and the second auxiliary rotor can be located at the first end of the center body. The third auxiliary rotor and the fourth auxiliary rotor can be located at the second end of the center body. The first housing can be located between the first auxiliary rotor and the second auxiliary rotor. The second housing can be located between the third auxiliary rotor and the fourth auxiliary rotor. The unmanned aerial vehicle can further include an optical sensor located at the first housing and a power source located at the second housing.

The primary rotor can be a first primary rotor. The unmanned aerial vehicle can further include a second primary rotor mounted to the primary shroud and disposed coaxially with the first primary rotor.

The primary rotor can be rotatable with respect to the primary shroud about a second axis that is oriented substantially perpendicular with respect to the center axis.

The first auxiliary rotor can be rotatable with respect to the center body about an axis that is substantially perpendicular with respect to a center axis of the first auxiliary rotor.

The first housing can include a payload attachment point configured to receive at least one of a sensor or a power source. The second housing can be configured to receive at least one power source removably coupled thereto.

In another aspect, the subject matter may be embodied in a method for operating an unmanned aerial vehicle. The method can include positioning a primary shroud in a first orientation with respect to a center body, a primary rotor is mounted to the primary shroud and defines a rotor axis, and the center body at least partially surrounds the primary shroud and defines a center axis. The method can further include rotating the primary shroud with respect to the center body from the first orientation, wherein the rotor axis and the center axis are substantially parallel, to a second orientation, wherein the rotor axis and the center axis are substantially perpendicular.

In various aspects, the method can further include rotating a first auxiliary rotor with respect to the center body from the first orientation to the second orientation.

The method can further include rotating a second auxiliary rotor with respect to the center body from the first orientation to the second orientation.

Rotating the first auxiliary rotor with respect to the center body from the first orientation to the second orientation can change a direction of thrust generated by the first auxiliary rotor.

In another aspect, the subject matter may be embodied in an unmanned aerial vehicle, including a primary shroud, a primary rotor mounted to the primary shroud and defining a rotor axis, and a center body at least partially surrounding the primary shroud and defining a center axis, the primary shroud is rotatably coupled to the center body. The primary rotor and the primary shroud can be rotatable together between a first orientation with respect to the center body, wherein the rotor axis and the center axis are substantially parallel, and a second orientation with respect to the center body, wherein the rotor axis and the center axis are substantially perpendicular.

In various aspects, the unmanned aerial vehicle can further include a servo motor mounted to the center body. The servo motor can be configured to rotate the primary shroud with respect to the center body between the first orientation and the second orientation.

The primary rotor can be rotatable with respect to the primary shroud about a second axis that is oriented substantially perpendicular with respect to the center axis.

The unmanned aerial vehicle can further include a plurality of auxiliary propulsion units mounted to the center body, wherein each auxiliary propulsion unit is rotatable with respect to the center body.

The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1A is a schematic view of an unmanned aerial vehicle with a primary shroud in a first rotational position, in accordance with various embodiments;

FIG. 1B is a schematic view of an unmanned aerial vehicle with the primary shroud and the auxiliary propulsion units in a second rotational position, in accordance with various embodiments;

FIG. 2 is a schematic view of a control unit for the unmanned aerial vehicle of FIG. 1A, in accordance with various embodiments;

FIG. 3A is a perspective view of an unmanned aerial vehicle, in accordance with various embodiments;

FIG. 3B is a perspective view of the unmanned aerial vehicle with the grilles omitted, in accordance with various embodiments;

FIG. 3C is a top view of the unmanned aerial vehicle, in accordance with various embodiments;

FIG. 3D is a bottom view of the unmanned aerial vehicle, in accordance with various embodiments;

FIG. 3E is a perspective view of a front end of the unmanned aerial vehicle, in accordance with various embodiments;

FIG. 3F is a front view of the unmanned aerial vehicle, in accordance with various embodiments;

FIG. 3G is a rear view of the unmanned aerial vehicle, in accordance with various embodiments;

FIG. 4A is a perspective view of the unmanned aerial vehicle in a vertical orientation with the primary shroud rotated to a second orientation with respect to the center body, in accordance with various embodiments;

FIG. 4B is a perspective view of the unmanned aerial vehicle in a vertical orientation with the auxiliary propulsion units rotated to second orientations with respect to the center body, in accordance with various embodiments; and

FIG. 4C is a side view of the unmanned aerial vehicle of FIG. 4B, in accordance with various embodiments.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the disclosure, it should be understood that other embodiments may be realized and that logical changes and adaptations in design and construction may be made in accordance with this disclosure and the teachings herein. Thus, the detailed description herein is presented for purposes of illustration only and not of limitation. The scope of the disclosure is defined by the appended claims. For example, the steps recited in any of the method or process descriptions may be executed in any order and are not necessarily limited to the order presented. Furthermore, any reference to singular includes plural embodiments, and any reference to more than one component or step may include a singular embodiment or step.

As used herein, “electronic communication” means communication of electronic signals with physical coupling (e.g., “electrical communication” or “electrically coupled”) or without physical coupling and via an electromagnetic field (e.g., “inductive communication” or “inductively coupled” or “inductive coupling”).

As defined herein, “real-time” can, in some aspects, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used herein, the term “drone” refers to unmanned aerial vehicles according to various embodiments. A drone can be fully or partially autonomous. In various aspects, a drone may be controlled remotely by a human pilot. In various aspects, a drone may include an onboard computing device configured to fly and/or operate the drone without remote operating instructions (i.e., autonomously), such as from a human operator or remote computing device. In various aspects, the onboard computing device may be configured to fly and/or operate the drone with some remote operating instruction or updates to instructions stored in a memory of the onboard computing device.

Systems, methods, and apparatus for a drone include a shrouded primary propulsion unit and a plurality of auxiliary propulsion units. The primary propulsion unit is rotatable with respect to a center body of the drone to generate a primary lift or thrust for the drone in various orientations. In various embodiments, the primary propulsion unit is rotatable with respect to the center body by about ninety degrees between a first orientation, wherein the primary propulsion unit provides primary lift for the drone in a horizontal orientation, and a second orientation, wherein the primary propulsion unit provides primary lift for the drone in a vertical orientation. The primary propulsion unit can be rotatable with respect to the center body by three hundred and sixty degrees. The auxiliary propulsion units can also be rotatable with respect to the center body of the drone to provide one or more of lift, stability, and directional control of the drone. In various aspects, the primary propulsion unit is rotatable about two axes. In various aspects, the auxiliary propulsion units are each rotatable about a single axis.

Various aspects of the drone allow for flying the drone in various orientations (e.g., horizontal, vertical, and various orientations therebetween). Accordingly, the body of the drone can be oriented in various directions for maneuvering through confined spaces, around objects, and/or for inspecting various surfaces and/or features of an object from various angles. In this regard, the drone is capable of omnidirectional orientation. Various aspects of the drone provide the ability to achieve stable contact and exert physical force on surfaces and structures at any orientation.

Various aspects of the drone include a rechargeable power source located onboard the drone. An electronics package (e.g., sensors, lights, controllers, etc.) can be located at a first end of the drone and the power source can be located at a second, opposite, end of the drone. In this manner, the power source can be sized and configured to counterbalance the components located at the first end of the drone. A drone of the present disclosure may have the ability to fly using a rechargeable power source (batteries) or with a tether to enable unlimited flight time for time consuming missions.

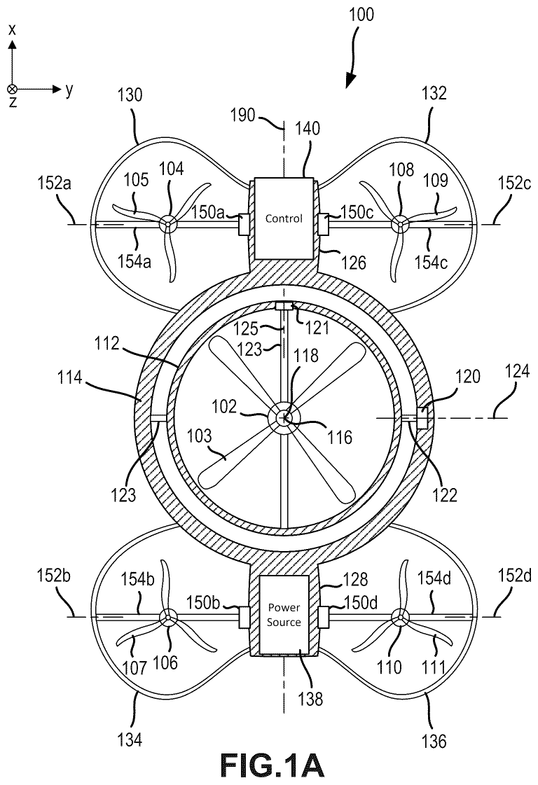

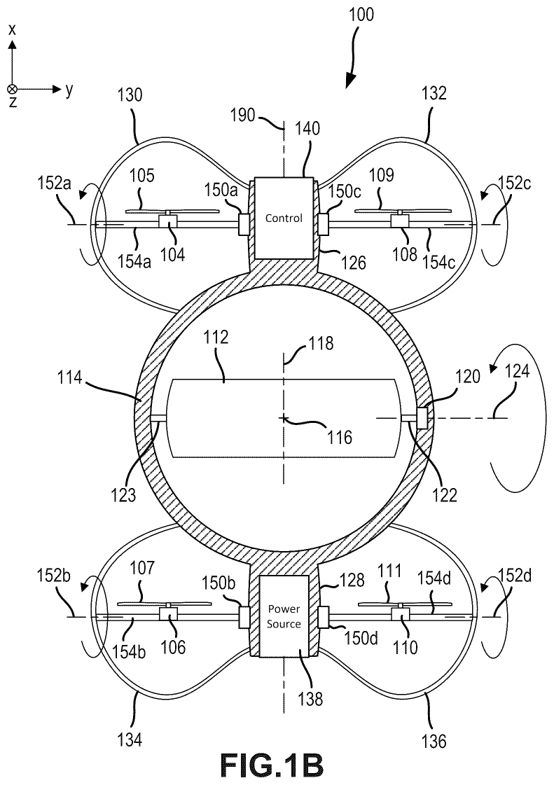

With reference to FIG. 1A and FIG. 1B, a unmanned aerial vehicle 100 (also referred to herein as a drone) with a primary propulsion unit 102 (also referred to herein as a “primary rotor”) and a plurality of auxiliary propulsion units 104, 106, 108, 110 (also referred to herein as a “auxiliary rotors”) is illustrated, in accordance with various embodiments. Each of the primary propulsion unit 102 and the plurality of auxiliary propulsion units 104, 106, 108, 110 can include an electric motor (e.g., an electric brushless DC motor or any other suitable electric motor) and a plurality of propellers for generating lift and/or thrust depending on the operating mode of the particular propulsion unit. The primary propulsion unit 102 can comprise the primary thrust generation and the auxiliary propulsion units 104, 106, 108, 110 can provide one or more of lift, stability, and directional control of the drone 100.

The drone 100 can include a primary shroud 112 surrounding the primary propulsion unit 102. The drone 100 can include a center body 114 at least partially surrounding the primary shroud 112. The center body 114 can define a center axis 116. The primary propulsion unit 102 can be mounted to the primary shroud 112. The primary propulsion unit 102 can include a plurality of propellers 103 (also referred to as “rotors”) configured to rotate about a rotor axis 118. In various embodiments, the center axis 116 and the rotor axis 118 are coaxial. In various embodiments, the center axis 116 and the rotor axis 118 are parallel.

The primary shroud 112 can be rotatably coupled to the center body 114. The primary propulsion unit 102 and the primary shroud 112 can be rotatable together between a first orientation with respect to the center body 114 (see FIG. 1A), wherein the rotor axis 118 and the center axis 116 are substantially parallel, and a second orientation with respect to the center body 114 (see FIG. 1B), wherein the rotor axis 118 and the center axis 116 are substantially perpendicular. In the first orientation (see FIG. 1A), the center axis 116 can be oriented substantially vertically (i.e., FIG. 1A can be considered a top view of the drone 100 in flight). In the second orientation (see FIG. 1B), the center axis 116 can be oriented substantially horizontally (i.e., FIG. 1B can be considered a side view of the drone 100 in flight). In the second orientation illustrated in FIG. 1B, the primary propulsion unit 102 provides lift to maintain the drone 100 in the air, and the auxiliary propulsion units 104, 106, 108, 110 provide thrust to control and stabilize the drone's 100 orientation and direction. The auxiliary propulsion units 104, 106, 108, 110 can be rotated by about ninety degrees to move between the first orientation (see FIG. 1A) and the second orientation (see FIG. 1B). The auxiliary propulsion units 104, 106, 108, 110 can be rotated about their respective axes 152a, 152b, 152c, and 152d to stabilize and provide directional control to the drone 100. The primary propulsion unit 102 and the auxiliary propulsion units 104, 106, 108, 110 can be rotated by any rotational amount to provide lift and/or thrust in any desired direction.

The drone 100 can include a motor 120 configured to rotate the primary shroud 112 with respect to the center body 114. The motor 120 can be a servo motor. The motor 120 can cause the primary shroud 112 to rotate about a motor axis 124. The motor 120 can cause the primary shroud 112 to rotate between ninety degrees and three hundred and sixty degrees about the motor axis 124. The motor axis 124 can be oriented substantially perpendicular to the center axis 116. The motor axis 124 can be oriented substantially perpendicular to the rotor axis 118. The motor 120 can cause the primary shroud 112 to rotate from the first orientation with respect to the center body 114 (see FIG. 1A), wherein the rotor axis 118 and the center axis 116 are substantially parallel and/or substantially coaxial, and the second orientation with respect to the center body 114 (see FIG. 1B), wherein the rotor axis 118 and the center axis 116 are substantially perpendicular. In the first orientation, the primary propulsion unit 102 can provide lift/thrust along the center axis 116 and the center body 114 can be oriented substantially horizontally. In the second orientation, the primary propulsion unit 102 can provide lift/thrust perpendicular to the center axis 116 (e.g., along a longitudinal axis 190 of the center body 114) such that the center body 114 is oriented substantially vertically.

In various embodiments, the primary shroud 112 is pivotally coupled to the center body 114 via a first pivot point 122 (e.g., a rod, shaft, pin, or the like) and a second pivot point 123 (e.g., a rod, shaft, pin, or the like) located at opposite sides of the primary shroud 112. The first pivot point 122 can be operatively coupled to the motor 120. The first pivot point 122 can extend from the motor 120. The first pivot point 122 can extend between and to the primary shroud 112 and the center body 114. The second pivot point 123 can extend between and to the primary shroud 112 and the center body 114. The first pivot point 122 and the second pivot point 123 can be oriented coaxially.

In various embodiments, and with reference to FIG. 1A, the drone 100 can include a motor 121 configured to rotate the primary propulsion unit 102 with respect to the primary shroud 112. The motor 121 can be a servo motor. The motor 121 can cause the primary propulsion unit 102 to rotate about a motor axis 125. The motor axis 125 can be oriented substantially perpendicular to the center axis 116. The motor axis 125 can be oriented substantially perpendicular to the rotor axis 118. The motor axis 125 can be oriented substantially perpendicular to the motor axis 124. The primary propulsion unit 102 can be rotated about the motor axis 125 to control y-axis motion of the drone 100. In various embodiments, the primary propulsion unit 102 is pivotally coupled to the primary shroud 112 via a pivot 123 (e.g., a rod, shaft, pin, or the like). The pivot 123 can be operatively coupled to the motor 121. The pivot 123 can extend from the motor 121. The pivot 123 can extend between and to opposing inner surfaces of the primary shroud 112. The pivot 123 can bisect the primary shroud 112.

The auxiliary propulsion units 104, 106, 108, 110 can be located distal to the center body 114. The auxiliary propulsion units 104, 106, 108, 110 can be located distal to the primary shroud 112. The auxiliary propulsion units 104, 106, 108, 110 can include a plurality of propellers 105, 107, 109, 111, respectively, (also referred to as “rotors” or “blades”) configured to rotate about a respective rotor axis of the respective auxiliary propulsion unit 104, 106, 108, 110. Each auxiliary propulsion unit 104, 106, 108, 110 can be operated independently of the other auxiliary propulsion units 104, 106, 108, 110.

In various embodiments, the primary propulsion unit 102 can be operated at a slower rotational speed than the auxiliary propulsion units 104, 106, 108, 110. An efficiency of the primary propulsion unit 102 can be greater than that of the auxiliary propulsion units 104, 106, 108, 110, for example at least in part due to the overall propeller diameter of the propellers of the primary propulsion unit 102 (i.e., the distance across the circle formed by the tips of its blades as it rotates) compared to that of the auxiliary propulsion units 104, 106, 108, 110. In this regard, an overall length of the propellers 103 can be greater than the length of the propellers 105, 107, 109, 111 of the auxiliary propulsion units.

The drone 100 can include a first housing 126 located at a first end of the center body 114 and extending outward from the center body 114 away from the center axis 116. Various electronics can be enclosed within the first housing 126. The first housing 126 can be located between the auxiliary propulsion unit 104 and the auxiliary propulsion unit 108. The auxiliary propulsion unit 104 and the auxiliary propulsion unit 108 can be located at opposite sides of the first housing 126.

A support structure 130 can extend at least partially around the auxiliary propulsion unit 104. The support structure 130 can extend between the first housing 126 and the center body 114. The support structure 130 can extend between and to the first housing 126 and the center body 114. The support structure 130 can be configured to be located distally from the auxiliary propulsion unit 104 so as to protect the rotor blades of the auxiliary propulsion unit 104 from contacting foreign objects. The support structure 130 can extend between ninety degrees and three hundred and sixty degrees (90°-360°) around the auxiliary propulsion unit 104 in various embodiments, between one hundred and forty-five degrees and three hundred degrees (145°-300°) around the auxiliary propulsion unit 104 in various embodiments, or between one hundred and eighty degrees and two hundred and seventy degrees (180°-270°) around the auxiliary propulsion unit 104 in various embodiments.

A support structure 132 can extend at least partially around the auxiliary propulsion unit 108. The support structure 132 can extend between the first housing 126 and the center body 114. The support structure 132 can extend between and to the first housing 126 and the center body 114. The support structure 132 can be configured to be located distally from the auxiliary propulsion unit 108 so as to protect the rotor blades of the auxiliary propulsion unit 108 from contacting foreign objects. The support structure 132 can be arranged as a mirror image of the support structure 130. The support structure 132 can extend between ninety degrees and three hundred and sixty degrees (90°-360°) around the auxiliary propulsion unit 108 in various embodiments, between one hundred and forty-five degrees and three hundred degrees (145°-300°) around the auxiliary propulsion unit 108 in various embodiments, or between one hundred and eighty degrees and two hundred and seventy degrees (180°-270°) around the auxiliary propulsion unit 108 in various embodiments.

The drone 100 can include a second housing 128 located at a second end of the center body 114 and extending outward from the center body 114 away from the center axis 116. Various electronics can be enclosed within the second housing 128. The second housing 128 can be located between the auxiliary propulsion unit 106 and the auxiliary propulsion unit 110. The auxiliary propulsion unit 106 and the auxiliary propulsion unit 110 can be located at opposite sides of the second housing 128.

A support structure 134 can extend at least partially around the auxiliary propulsion unit 106. The support structure 134 can extend between the second housing 128 and the center body 114. The support structure 134 can extend between and to the second housing 128 and the center body 114. The support structure 134 can be configured to be located distally from the auxiliary propulsion unit 106 so as to protect the rotor blades of the auxiliary propulsion unit 106 from contacting foreign objects. The support structure 134 can extend between ninety degrees and three hundred and sixty degrees (90°-360°) around the auxiliary propulsion unit 106 in various embodiments, between one hundred and forty-five degrees and three hundred degrees (145°-300°) around the auxiliary propulsion unit 106 in various embodiments, or between one hundred and eighty degrees and two hundred and seventy degrees (180°-270°) around the auxiliary propulsion unit 106 in various embodiments.

A support structure 136 can extend at least partially around the auxiliary propulsion unit 110. The support structure 136 can extend between the second housing 128 and the center body 114. The support structure 136 can extend between and to the second housing 128 and the center body 114. The support structure 136 can be configured to be located distally from the auxiliary propulsion unit 110 so as to protect the rotor blades of the auxiliary propulsion unit 110 from contacting foreign objects. The support structure 136 can extend between ninety degrees and three hundred and sixty degrees (90°-360°) around the auxiliary propulsion unit 110 in various embodiments, between one hundred and forty-five degrees and three hundred degrees (145°-300°) around the auxiliary propulsion unit 110 in various embodiments, or between one hundred and eighty degrees and two hundred and seventy degrees (180°-270°) around the auxiliary propulsion unit 110 in various embodiments. The support structure 136 can be arranged as a mirror image of the support structure 134. The support structures 134, 136 can be arranged as a mirror image of the support structures 130, 132.

The auxiliary propulsion units 104, 108 can be located at the first end of the center body 114. The auxiliary propulsion units 106, 110 can be located at the second end of the center body 114. The auxiliary propulsion units 106, 110 can be positioned in a mirror-image configuration of the auxiliary propulsion units 104, 108 about the motor axis 124. Although described herein as having four auxiliary propulsion units 104, 106, 108, 110, it is contemplated that the drone 100 can be configured with fewer or more auxiliary propulsion units (e.g., two auxiliary propulsion units, three auxiliary propulsion units, five auxiliary propulsion units, six auxiliary propulsion units, etc.). For example, the drone 100 can include only one auxiliary propulsion unit located at the first end and only one auxiliary propulsion unit located at the second end; or the drone 100 can include only one auxiliary propulsion unit located at the first end and two auxiliary propulsion units located at the second end, or vice-versa.

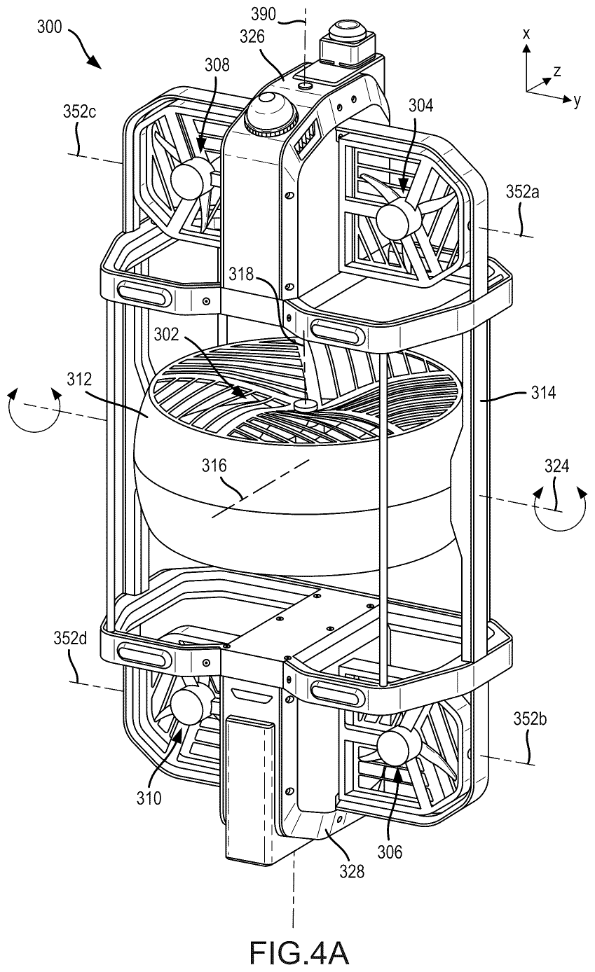

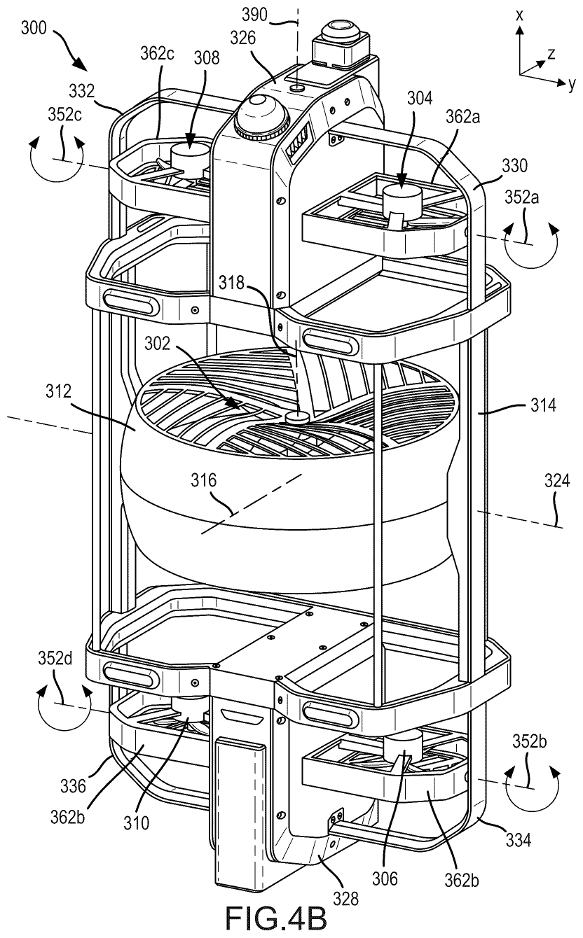

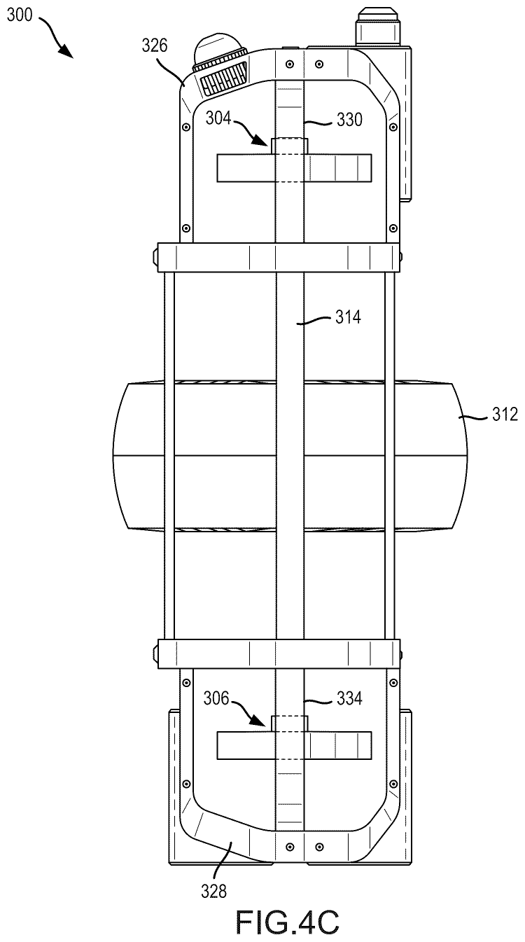

In various embodiments, each of the auxiliary propulsion units 104, 106, 108, 110 can be pivotally coupled to the respective support structure via a motor 150a, 150b, 150c, 150d, respectively. Each of the motors 150a, 150b, 150c, 150d, can be configured to rotate the respective auxiliary propulsion unit 104, 106, 108, 110 with respect to the center body 114. Each of the motors 150a, 150b, 150c, 150d can be a servo motor. The motors 150a, 150b, 150c, 150d can cause the auxiliary propulsion units 104, 106, 108, 110 to rotate about a motor axis 152a, 152b, 152c, 152d, respectively. Each motor axis 152a, 152b, 152c, 152d can be oriented substantially perpendicular to the center axis (i.e., the rotational axis of the propellers) of each of the auxiliary propulsion units 104, 106, 108, 110. Each motor axis 152a, 152b, 152c, 152d can be oriented substantially perpendicular to the center axis 116. Each motor axis 152a, 152b, 152c, 152d can be oriented substantially perpendicular to the rotor axis 118. The motors 150a, 150b, 150c, 150d can cause the auxiliary propulsion units 104, 106, 108, 110 to independently rotate about the motor axis 152a, 152b, 152c, 152d, respectively, to control a direction of flight of the drone 100 (e.g., see FIG. 4B). The primary propulsion unit 102 can provide a primary lift force to the drone 100 while the auxiliary propulsion units 104, 106, 108, 110 provide fine adjustments to the flight and/or orientation of the drone 100. The auxiliary propulsion units 104, 106, 108, 110 can provide accurate and precise control of the flight and/or orientation of the drone 100.

In various embodiments, the auxiliary propulsion unit 104 is pivotally coupled between the first housing 126 and the support structure 130 via a pivot 154a (e.g., a rod, shaft, pin, or the like). The pivot 154a can be operatively coupled to the motor 150a. The pivot 154a can extend from the motor 150a.

In various embodiments, the auxiliary propulsion unit 106 is pivotally coupled between the second housing 128 and the support structure 134 via a pivot 154b (e.g., a rod, shaft, pin, or the like). The pivot 154b can be operatively coupled to the motor 150b. The pivot 154b can extend from the motor 150b.

In various embodiments, the auxiliary propulsion unit 108 is pivotally coupled between the first housing 126 and the support structure 132 via a pivot 154c (e.g., a rod, shaft, pin, or the like). The pivot 154c can be operatively coupled to the motor 150c. The pivot 154c can extend from the motor 150c.

In various embodiments, the auxiliary propulsion unit 110 is pivotally coupled between the second housing 128 and the support structure 136 via a pivot 154d (e.g., a rod, shaft, pin, or the like). The pivot 154d can be operatively coupled to the motor 150d. The pivot 154d can extend from the motor 150d.

One or more power sources 138 (e.g., a battery) can be located at the second housing 128. The power source 138 can be used for powering various components of the drone 100, including the primary propulsion unit 102 and the auxiliary propulsion units 104, 106, 108, 110. In various embodiments, the power source 138 is removably coupled to the second housing 128. The power source 138 can be recharged between flights. The power source 138 can include one or more Lithium-Ion batteries. The power source 138 can include one or more Lithium Polymer (LiPo) batteries, Lithium-Ion (Li-ion) batteries, Nickel Metal Hydride (NiMH) batteries, and/or Nickel Cadmium (NiCd) batteries.

The drone 100 may include a control unit 140 disposed in the first housing 126 that may house various circuits and devices used to power and control the operations of the drone 100. Various components of the control unit 140 described herein can be powered by the power source 138.

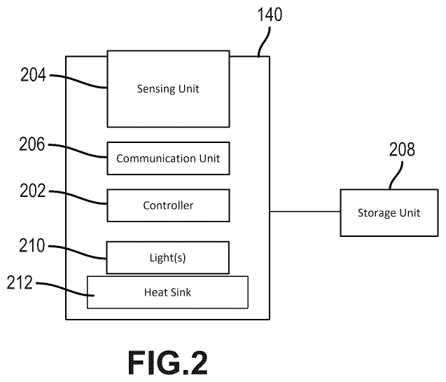

With reference to FIG. 2, a schematic view of the control unit 140 is illustrated, in accordance with various embodiments. The control unit 140 can include one or more processors 202 and one or more tangible, non-transitory memories capable of implementing digital or programmatic logic. In various embodiments, for example, the one or more controllers are one or more of a general purpose processor, digital signal processor (DSP), application specific integrated circuit (ASIC), field programmable gate array (FPGA), or other programmable logic device, discrete gate, transistor logic, or discrete hardware components, or any various combinations thereof or the like. With combined reference to FIG. 1A and FIG. 2, the processor 202 can be in electronic communication with the propulsion units 102, 104, 106, 108, 110 and the servo motors 120, 121, 150a, 150b, 150c, 150d. In various embodiments, the processor 202 is configured to control the propulsion units 102, 104, 106, 108, 110 and the servo motors 120, 121, 150a, 150b, 150c, 150d. The processor 202 may send control signals to the servo motors 120, 121, 150a, 150b, 150c, 150d and the propulsion units 102, 104, 106, 108, 110. The control signals sent from the processor 202 to the servo motors 120, 121, 150a, 150b, 150c, 150d control the direction and speed of rotation of the propulsion units 102, 104, 106, 108, 110, while the control signals sent from the processor to the propulsion units 102, 104, 106, 108, 110 control the direction and speed of the propellers 103, 105, 107, 109, 111 coupled to the propulsion units.

The drone 100 can measure its own flight state using a variety of types of sensors in order to fly stably. The flight state of the drone 100 can be defined as rotational states and translational states. The rotational states mean “yaw”, “pitch”, and “roll.” The translational states mean longitude, latitude, altitude, and velocity. “Roll”, “pitch”, and “yaw” are called Euler angle, and indicate that the x, y, z three axes of an aircraft body frame coordinate have been rotated with respect to a given specific coordinate, for example, three axes of north-east-down (NED) coordinates N, E, D. If the front of an aircraft is rotated left and right on the basis of the z axis of a body frame coordinate, the x axis of the body frame coordinate has an angle difference with the N axis of the NED coordinate, and this angle is called “yaw” (Y). If the front of an aircraft is rotated up and down on the basis of the y axis toward the right, the z axis of the body frame coordinate has an angle difference with the D axis of the NED coordinates, and this angle is called a “pitch” (θ). If the body frame of an aircraft is inclined left and right on the basis of the x axis toward the front, the y axis of the body frame coordinate has an angle to the E axis of the NED coordinates, and this angle is called “roll” (φ).

The drone 100 can use one or more 3-axis gyroscopes, 3-axis accelerometers, and 3-axis magnetometers in order to measure the rotational states, and uses a GPS sensor and a barometric pressure sensor in order to measure the translational states. The drone 100 can use a LiDAR sensor (e.g., see the LiDAR sensor 372) to serve as sensor for absolute position using LiDAR-SLAM algorithms running onboard the flight computer (e.g., the control unit 140).

The drone 100 can include a sensing unit 204 including at least one sensor. The processor 202 can be in electronic communication with the sensing unit 204. The processor 202 may receive sensing information from the sensing unit 204 and may process the sensing information. The sensing unit 204 can include a gyroscope, an accelerometer, a GPS sensor, an image sensor, an optical sensor (e.g., LiDAR), a thermal sensor, a barometric pressure sensor, an ultrasonic sensor, a strain measurement sensor, a pulse eddy current sensor, and/or other sensors. The gyroscope and the accelerometer can measure the states in which the body frame coordinates of the drone 100 have been rotated and accelerated with respect to earth centered inertial coordinate. The gyroscope and the accelerometer may be fabricated as a single chip called an inertial measurement unit (IMU) using a micro-electro-mechanical systems (MEMS) semiconductor process technology.

Furthermore, the IMU chip may include a microcontroller for converting measurement values based on the earth centered inertial coordinates, measured by the gyroscopes and the accelerometers, into local coordinates, for example, north-east-down (NED) coordinates used by GPSs.

The gyroscope(s) can measure angular velocity at which the body frame coordinate x, y, z three axes of the drone 100 rotate with respect to the earth centered inertial coordinates, calculate values (Wx.gyro, Wy.gyro, Wz.gyro) converted into fixed coordinates, and convert the values into Euler angles (φgyro, θgyro, ψgyro) using a linear differential equation.

The accelerometer(s) can measure acceleration for the earth centered inertial coordinates of the body frame coordinate x, y, z three axes of the unmanned aerial vehicle 100, calculate values (fx,acc, fy,acc, fz,acc) converted into fixed coordinates, and convert the values into “roll (φacc)” and “pitch (θacc).” The values are used to remove a bias error included in “roll (φgyro)” and “pitch (θgyro)” using measurement values of the gyroscopes.

The magnetometer(s) can measure the direction of magnetic north points of the body frame coordinate x, y, z three axes of the unmanned aerial vehicle 100, and calculate a “yaw” value for the NED coordinates of body frame coordinates using the value.

The GPS sensor can calculate the translational states of the unmanned aerial vehicle 100 on the NED coordinates, that is, a latitude (Pn.GPS), a longitude (Pe.GPS), an altitude (hMSL.GPS), velocity (Vn.GPS) on the latitude, velocity (Ve.GPS) on longitude, and velocity (Vd.GPS) on the altitude, using signals received from GPS satellites. In this case, the subscript MSL means a mean sea level (MSL).

The barometric pressure sensor may measure the altitude (hALP.baro) of the unmanned aerial vehicle 100. In this case, the subscript ALP means an air-level pressor. The barometric pressure sensor can calculate a current altitude from a take-off point by comparing an air-level pressor when the drone 100 takes off with an air-level pressor at a current flight altitude.

The camera sensor may include an image sensor (e.g., CMOS image sensor), including at least one optical lens and multiple photodiodes (e.g., pixels) on which an image is focused by light passing through the optical lens, and a digital signal processor (DSP) configuring an image based on signals output by the photodiodes. The DSP may generate a moving image including frames configured with a still image, in addition to a still image.

The sensing unit 204 can include sensors (e.g., LiDAR, thermal, cameras, audio, etc.) to provide accurate and real-time data about the environment including distances, objects, and obstacles. This information can be used for navigation, autonomous driving, and even advanced mapping for various industries. In an example, the processor 202 can process data from LIDAR, cameras, and/or other sensors to make informed decisions. In autonomous driving, the processor 202 may analyze the data to navigate, avoid obstacles, and follow traffic rules. In an example, one or more sensors, such as including LIDAR and camera sensors, can provide a comprehensive view of the surroundings. The processor 202 can use this data to recognize objects, pedestrians, road signs, and/or other vehicles, enhancing safety and awareness for the drone 100. In an example, the drone 100 can be equipped with one or more optical sensors, such as LIDAR and cameras, or one or more thermal sensors, such as infrared, for tasks such as infrastructure inspection, crop monitoring, and/or disaster assessment. The processor 202 can process the collected data to identify potential issues or anomalies. The processor 202 can process the collected data to identify a material's physical characteristics. In various aspects, the sensing unit 204 can include non-destructive testing sensors such as an electromagnetic acoustic transducer and/an ultrasonic thickness measurement sensor for remaining wall thickness measurement, a pulsed eddy current sensor for corrosion under insulation measurement, and/or a dry film thickness sensor or gauge for coating thickness measurement. In various aspects, the sensing unit 204 can include ground penetrating radar, a strain measurement device, or other sensor that is operated in contact with a structure.

The control unit 140 can include a communication unit 206 for inputting or receiving information or outputting or transmitting information. The processor 202 can be in electronic communication with the communication unit 206. The processor 202 can communicate with various onboard devices via the communication unit 206. The processor 202 can communication with various remote devices (e.g., a server, a computer, a personal device, a database, etc.) via the communication unit 206. For example, the drone 100 may output information to an external server, an external terminal, etc.

The communication unit 206 may receive information input from an external device, such as a smartphone or a computer. The communication unit 206 may output information to an external device, such as a smartphone or a computer. The communication unit 206 may receive various command signals from an external device. The communication unit 206 may receive area information for flight, a flight route, or a flight command from an external device. The processor 202 can processes and determine various pieces of information communicated via the communication unit 206.

The drone 100 can include a storage unit 208 for storing various data. The processor 202 can be in electronic communication with the storage unit 208. The storage unit 208 can be used to record various pieces of information desirable for control of the drone 100 and may include a volatile or non-volatile recording medium. A map for a flight area may be stored in the storage unit 28. The map may have been input by an external device capable of exchanging information with the drone 100 through the communication unit 206 or may have been autonomously learned and generated by the drone 100. In the former case, the external device may include a remote controller, a PDA, a laptop, a smartphone or a tablet on which an application for a map configuration has been mounted, for example.

In an example, mobile devices and/or computers can connect to the drone 100 via the communication unit 206 and/or remote sensors to provide real-time monitoring. This can be used for activities like inspections, object tracking, monitoring construction sites, and/or overseeing remote areas. In another example, data collected by LiDAR, cameras, and/or other sensors of the sensing unit 204 can be analyzed by the processor 202 to extract insights. This information can then be visualized on various devices, helping decision-makers in fields like structural inspection, urban planning, agriculture, and environmental monitoring. In an example, LiDAR can be used to create detailed 3D maps. In an example, LiDAR, cameras, and/or other sensor data can be used with augmented reality (AR) technology, where mobile devices and/or other computers create interactive AR experiences.

The sensing unit 204 can include one or more optical sensors disposed at the first housing 126. The optical sensor(s) can include a forward-facing laser scanner (e.g., a LiDAR sensor). The optical sensor(s) can be used for spatial awareness, mapping, and/or length/distance measurements. The optical sensor(s) can be used for examining a surface of an object. In various embodiments, the optical sensor(s) can include an ultrasonic sensor, for example which can assist in landing, hovering, flight, and ground tracking by detecting a distance between the drone 100 and one or more surrounding objects.

The control unit 140 can include one or more lights 210 which can be used in dark or dimly lighted areas. The processor 202 can be in electronic communication with the light(s) 210. The light 210 can assist various sensors of the sensing unit 204 (e.g., a camera) to gather image data to assist in flight control and/or inspection of a structure or object. The light 210 can be thermally coupled to a heat sink 212 which can help dissipate heat generated by the light 210 and prevent the light 210 from overheating.

In various aspects, the control unit 140 can include, and/or be in electronic communication with, a large language model (LLM). A LLM is a type of artificial intelligence (AI) program that is built on machine learning. The LLM may include hardware, for example, a sequence of logic units or software, for example, a program including a sequence of instructions, which can be executed to analyze the set of natural language prompts. In various aspects, the LLM can recognize natural language by a user to specify parameters of a mission and/or tasks to be carried out by the drone 100. The tasks can be carried out autonomously by the drone 100 based on natural language description.

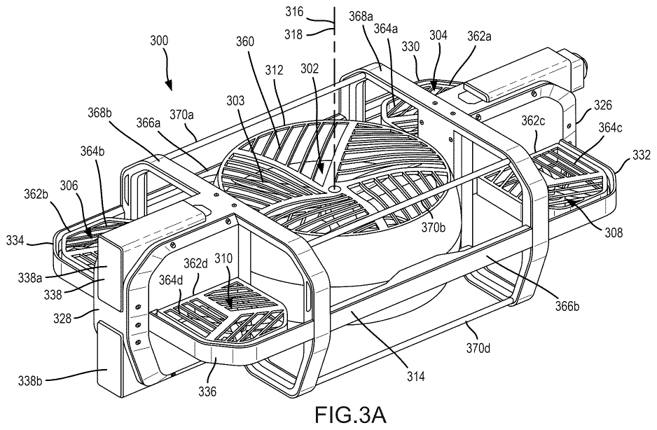

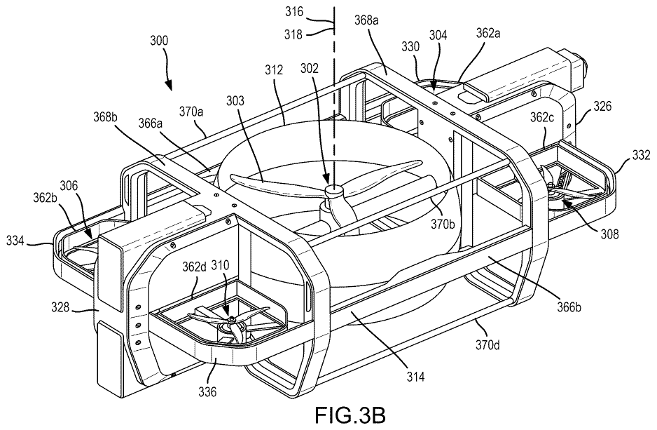

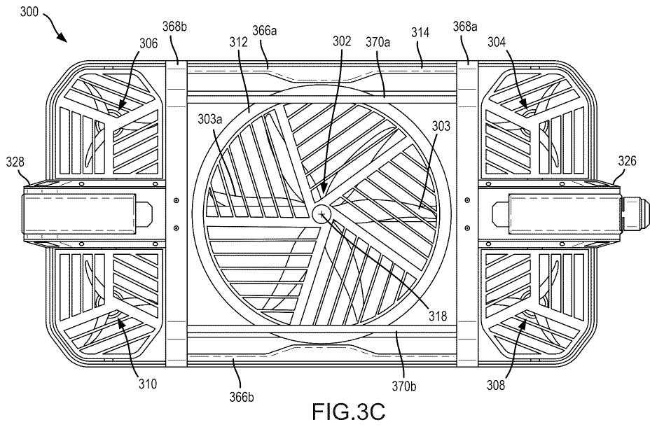

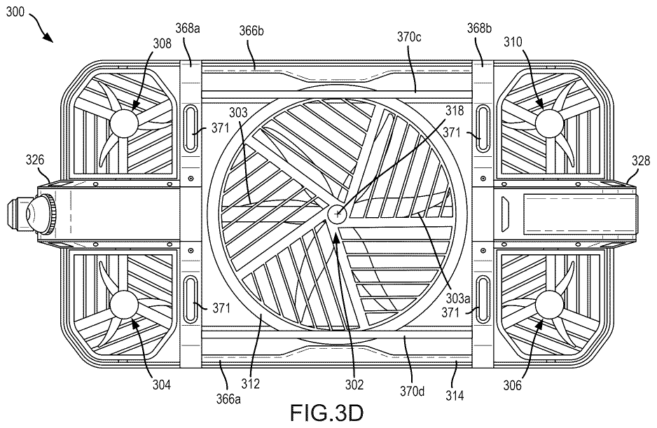

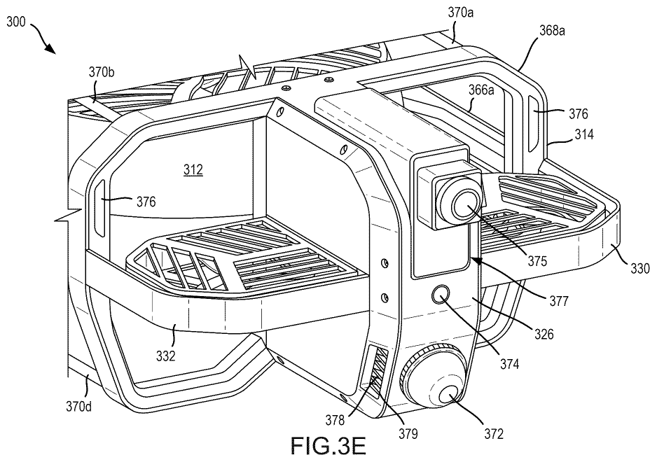

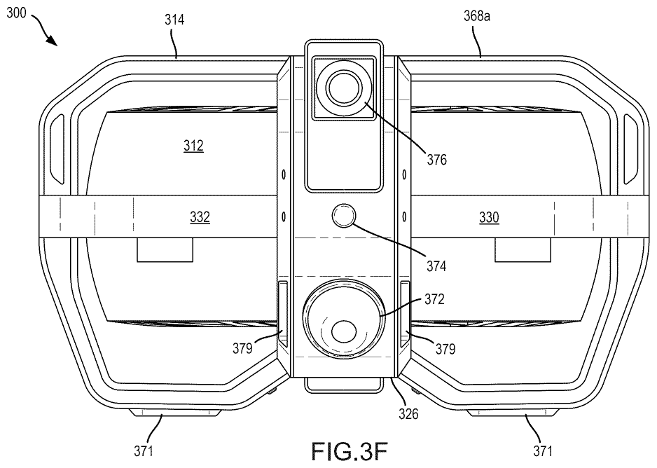

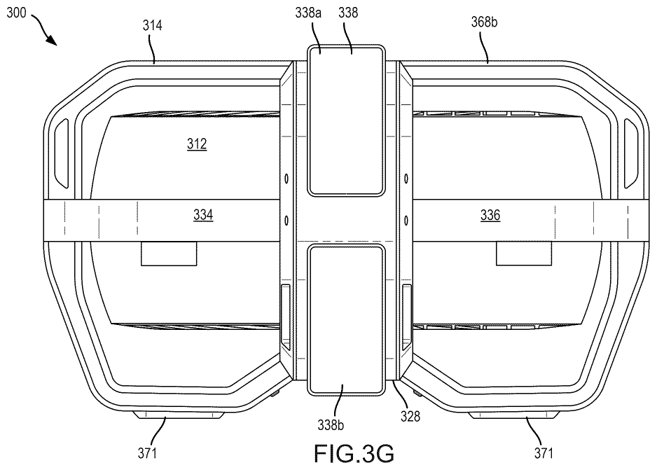

With reference to FIG. 3A, a unmanned aerial vehicle 300 (also referred to herein as a “drone”) with a primary propulsion unit 302 (also referred to herein as a “primary rotor”) and a plurality of auxiliary propulsion units 304, 306, 308, 310 (also referred to herein as a “auxiliary rotors”) is illustrated, in accordance with various embodiments. In various embodiments, the drone 300 is similar to the drone 100 described with respect to FIG. 1A through FIG. 2. Accordingly, various features of the drone 100 described with respect to FIG. 1A through FIG. 2 can similarly apply to the drone 300 and may not be repeated for sake of brevity.

The drone 300 can include a primary shroud 312 surrounding the primary propulsion unit 302. The drone 300 can include a center body 314 at least partially surrounding the primary shroud 312. The center body 314 can define a center axis 316. The primary propulsion unit 302 can be mounted to the primary shroud 312. The primary propulsion unit 302 can include a plurality of propellers 303 (also referred to as “rotors”) configured to rotate about a rotor axis 318. In various embodiments, the center axis 316 and the rotor axis 318 are coaxial. In various embodiments, the center axis 316 and the rotor axis 318 are parallel. In various embodiments, the primary shroud 312 and the propellers 303 can be sized and configured to minimize a distance between the inner diameter surface of the primary shroud 312 and a tip of each of the propellers 303 to increase aerodynamic efficiency of the primary propulsion unit 302.

A support structure 330, 332, 334, 336 can extend at least partially around each of the auxiliary propulsion units 304, 308, 306, 310, respectively. In various embodiments, the support structures 330, 332, 334, 336 can be similar to the support structures 130, 132, 134, 136 of FIG. 1A and FIG. 1B.

In various embodiments, each of the auxiliary propulsion units 304, 306, 308, 310 can be surrounded by a shroud 362a, 362b, 362c, 362d, respectively. In various embodiments, each shroud 362a, 362b, 362c, 362d is pivotally coupled to the respective support structure. For example, the shroud 362a can be pivotally coupled to the support structure 330 and/or the first housing 326, the shroud 362b can be pivotally coupled to the support structure 334 and/or the second housing 328, the shroud 362c can be pivotally coupled to the support structure 332 and/or the first housing 326, and the shroud 362d can be pivotally coupled to the support structure 336 and/or the second housing 328.

In various embodiments, the primary shroud 312 can include a grille 360 disposed at an inlet of the primary shroud 312. The grille 360 can comprise a grating or screen placed over the primary propulsion unit 302. The grille 360 can prevent foreign objects from entering the primary shroud 312 while still allowing air to flow through the primary shroud 312 for generating lift and/or thrust. The grille 360 can protect the primary propulsion unit 302 from foreign objects.

In various embodiments, each shroud 362a, 362b, 362c, 362d can include a grille 364a, 364b, 364c, 364d, respectively, disposed at an inlet thereof. Each grille 364a, 364b, 364c, 364d can comprise a grating or screen placed over the respective auxiliary propulsion unit 304, 306, 308, 310. The grilles 364a, 364b, 364c, 364d can prevent foreign objects from entering the respective primary shrouds 362a, 362b, 362c, 362d while still allowing air to flow through the shrouds 362a, 362b, 362c, 362d for generating lift and/or thrust. The grilles 364a, 364b, 364c, 364d can protect the respective auxiliary propulsion units 304, 306, 308, 310 from foreign objects.

FIG. 3B illustrates the drone 300 with the grilles 360, 364a, 364b, 364c, 364d omitted. In various embodiments, one or more of the grilles 360, 364a, 364b, 364c, 364d can be omitted if desired.

FIG. 3C is a top view of the drone 300, in accordance with various embodiments. In various embodiments, the primary propulsion unit 302 can include a second plurality of propellers 303a (also referred to as “rotors”) configured to rotate about the rotor axis 318. The second plurality of propellers 303a can be axially spaced apart from first plurality of propellers 303 along the rotor axis 318. The second plurality of propellers 303a can counterrotate with respect to the first plurality of propellers 303, in accordance with various embodiments. Accordingly, the primary propulsion unit 302 can include a first primary rotor and a second primary rotor mounted to the primary shroud 312. The second primary rotor can be disposed coaxially with the first primary rotor.

FIG. 3D is a bottom view of the drone 300, in accordance with various embodiments.

With combined reference to FIG. 3A through FIG. 3D, the center body 314 can include opposing elongated members 366a, 366b disposed at opposite sides of the primary shroud 312. The elongated members 366a, 366b can be oriented parallel to one another. The primary shroud 312 can be pivotally coupled to the elongated members 366a, 366b. The elongated members 366a, 366b can extend between and to opposing cross members 368a, 368b disposed at opposite sides of the primary shroud 312. The cross members 368a, 368b can be oriented parallel to one another. The first housing 326 can extend from the first cross member 368a. The second housing 328 can extend from the second cross member 368b.

The first support member 330 can extend between and to the first cross member 368a and the first housing 326. The second support member 332 can extend between and to the first cross member 368a and the first housing 326. The third support member 334 can extend between and to the second cross member 368b and the second housing 328. The fourth support member 336 can extend between and to the second cross member 368b and the second housing 328.

One or more support rods (e.g., support rods 370a, 370b, 370c, 370d; referred to generally as support rods 370) can extend between and to the first cross member 368a and the second cross member 368b. Support rod 370a and support rod 370b can be disposed at opposite sides of the primary shroud 312. Support rod 370c and support rod 370d can be disposed at opposite sides of the primary shroud 312. Support rod 370a and support rod 370c can be disposed at opposite sides of the elongated member 366a. Support rod 370b and support rod 370d can be disposed at opposite sides of the elongated member 366b. The support rods 370 can increase the stiffness and/or rigidity of the first cross member 368a and the second cross member 368b.

With particular focus on FIG. 3D, one or more feet 371 can be disposed on a bottom surface of the cross members 368a, 368b. The feet 371 can provide a contact surface for the drone 300 to rest on. In various embodiments, the cross member 368a includes two feet 371 and the cross member 368b includes two feet 371.

FIG. 3E is a perspective view of a front end of the drone 300, in accordance with various embodiments. One or more sensors can be housed in the first housing 326 to aid with flight of the drone 300. For example, an optical sensor 372 (e.g., a LiDAR sensor) can be disposed in or on the first housing 326. The optical sensor 372 can be a forward-facing optical sensor for mapping, object detection, and/or to aid in the flight of the drone 300. The optical sensor 372 can be thermally coupled to a heat sink 378 which can help dissipate heat generated by the optical sensor 372 and prevent the optical sensor 372 from overheating. Vents 379 can be disposed in the first housing 326 to allow air to flow through the first housing 326 to remove heat from the heat sink 378.

In various embodiments, a camera 374 (e.g., a video camera) can be disposed in or on the first housing 326 to gather image data to assist in flight control and/or inspection of a structure or object.

In various embodiments, the drone 300 can include one or more light sources 376. The light source(s) 376 can be disposed in the cross member 368a. The light source(s) 376 can additionally or alternatively be disposed in the first housing 326. The light source 376 can be an LED light. The light source 376 can assist in illuminating dark or dimly lighted areas. The light source 376 can be thermally coupled to the heat sink 378 which can help dissipate heat generated by the light source 376 and prevent the light source 376 from overheating.

In various embodiments, the first housing 326 includes a payload attachment point 377 whereby a payload 375 is removably coupled to the first housing 326. In the illustrated embodiment, the payload 375 can be a sensor, a light source, a battery pack, or any other desired payload, depending on the desired mission parameters/goals. The payload attachment point 377 can be formed as a slot disposed in the first housing 326.

FIG. 3F is a front view of the drone 300, in accordance with various embodiments.

FIG. 3G is a rear view of the drone 300, in accordance with various embodiments. One or more power sources 338 (e.g., a battery) can be located at the second housing 328. The power source 338 can be used for powering various components of the drone 300. By disposing the power source 338 at the second housing 328, the power source 338 can act as a counterbalance to the weight of the electronics package in the first housing 326.

In various embodiments, the power source 338 can include a first removable power source 338a and a second removable power source 338b. The first removable power source 338a and/or the second removable power source 338b can be replaceable by some other type of payload. In this regard, the second housing 328 can include a payload attachment point configured to receive the first removable power source 338a and/or the second removable power source 338b. In this regard, a payload can be replaced by the first removable power source 338a and/or the second removable power source 338b in exchange for a longer flight time. In various embodiments, the first removable power source 338a or the second removable power source 338b can be replaced by a payload, sacrificing flight time for payload capacity.

In various embodiments, the first removable power source 338a and/or the second removable power source 338b of the drone 300 provide the ability to maintain the same or similar center of mass of the drone between different combinations of payloads and battery modules.

In various embodiments, the first housing 326 can include a payload attachment point configured to attach to a desired payload. In various embodiments, the payload can be replaced by a battery for a longer flight time.

FIG. 4A and FIG. 4C are perspective and side views, respectively, of the drone 300 with the primary shroud 312 rotated to a second orientation, in accordance with various embodiments. FIG. 4B is perspective view of the drone 300 with the primary shroud 312 rotated to a second orientation and the auxiliary propulsion units 304, 306, 308, 310 rotated to second orientations, in accordance with various embodiments.

With combined reference to FIG. 4A through FIG. 4C, the primary propulsion unit 302 and the primary shroud 312 can be rotatable together between a first orientation with respect to the center body 314 (see FIG. 3A), wherein the rotor axis 318 and the center axis 316 are substantially parallel, and a second orientation with respect to the center body 314 (see FIG. 4A), wherein the rotor axis 318 and the center axis 316 are substantially perpendicular. The primary shroud 312 can be rotated about a motor axis 324 by a motor (e.g., see the motor 120 of FIG. 1B) as described with respect to the drone 100 herein, in accordance with various embodiments. In this manner, the center body 314 of the drone 300 can be rotated between a generally horizontal position with the primary shroud 312 in the first orientation and a vertical position with the primary shroud 312 in the second orientation. In the second orientation, the primary propulsion unit 302 can generate thrust/lift along a longitudinal axis 390 of the center body 314. It may be desirable to change the orientation of the drone 300 between the horizontal and vertical orientations to access locations with limited space (e.g., pipes, shafts, manholes, etc.). It may be desirable to change the orientation of the drone 300 (e.g., the center body 314 and attached components) between the horizontal and vertical orientations to inspect various surfaces of a structure or object. Accordingly, the design of the drone 300 allows for flexibility in the orientation of the center body 314 (and first housing 326 which includes the sensor package) in virtually any orientation or direction for accessing confined spaces and/or inspection of various surfaces (e.g., top, sides, and bottom surfaces) of an object.

With reference to FIG. 4B, the auxiliary propulsion units 304, 306, 308, 310 can be independently rotated about the respective motor axis 352a, 352b, 352c, 352d to provide lift, stability, and/or directional control of the drone 300. The auxiliary propulsion units 304, 306, 308, 310 can be mounted to their respective shrouds 362a, 362b, 362c, 362d. The shrouds 362a, 362b, 362c, 362d can be independently rotated about the respective motor axis 352a, 352b, 352c, 352d. The auxiliary propulsion units 304, 306, 308, 310 can rotate together with the respective shroud 362a, 362b, 362c, 362d. The shrouds 362a, 362b, 362c, 362d can be rotated about a respective motor axis 352a, 352b, 352c, 352d by a motor (e.g., see the motors 150 of FIG. 1B) as described with respect to the drone 100 herein, in accordance with various embodiments. Rotating the auxiliary propulsion units 304, 306, 308, 310 with respect to the center body 314 from a first orientation (e.g., see FIG. 4A) to a second orientation (e.g., see FIG. 4B) changes a direction of thrust generated by the auxiliary propulsion units 304, 306, 308, 310 (i.e., changes the direction of thrust from along the z-direction in the first orientation to along the x-direction in the second orientation). In various embodiments, the pair of auxiliary propulsion units 304, 308 can be counterrotated with respect to the pair of auxiliary propulsion units 306, 310 to cause the drone 300 to rotate about the motor axis 324. In various embodiments, the pair of auxiliary propulsion units 304, 306 can be counterrotated with respect to the pair of auxiliary propulsion units 308, 310 to cause the drone 300 to rotate about the longitudinal axis 390.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is intended to invoke 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. An unmanned aerial vehicle comprising:
a primary shroud;
a primary rotor mounted to the primary shroud and defining a rotor axis;
a center body at least partially surrounding the primary shroud and defining a center axis, the primary shroud is rotatably coupled to the center body;
a first auxiliary rotor located distal to the center body; and
a second auxiliary rotor located distal to the center body.

2. The unmanned aerial vehicle of claim 1, wherein the primary rotor and the primary shroud are rotatable together between a first orientation with respect to the center body, wherein the rotor axis and the center axis are substantially parallel, and a second orientation with respect to the center body, wherein the rotor axis and the center axis are substantially perpendicular.

3. The unmanned aerial vehicle of claim 1, further comprising a first housing located at a first end of the center body and extending outward from the center body away from the center axis.

4. The unmanned aerial vehicle of claim 3, further comprising a second housing located at a second end of the center body, opposite the first end, and extending outward from the center body away from the center axis.

5. The unmanned aerial vehicle of claim 4, further comprising a third auxiliary rotor located distal to the center body.

6. The unmanned aerial vehicle of claim 5, further comprising a fourth auxiliary rotor located distal to the center body, the first auxiliary rotor and the second auxiliary rotor are located at the first end of the center body and the third auxiliary rotor and the fourth auxiliary rotor are located at the second end of the center body.

7. The unmanned aerial vehicle of claim 6, wherein the first housing is located between the first auxiliary rotor and the second auxiliary rotor, and the second housing is located between the third auxiliary rotor and the fourth auxiliary rotor.

8. The unmanned aerial vehicle of claim 7, further comprising an optical sensor located at the first housing and a power source located at the second housing.

9. The unmanned aerial vehicle of claim 1, wherein the primary rotor is a first primary rotor, and the unmanned aerial vehicle further comprises a second primary rotor mounted to the primary shroud and disposed coaxially with the first primary rotor.

10. The unmanned aerial vehicle of claim 2, wherein the primary rotor is rotatable with respect to the primary shroud about a second axis that is oriented substantially perpendicular with respect to the center axis.

11. The unmanned aerial vehicle of claim 2, wherein the first auxiliary rotor is rotatable with respect to the center body about an axis that is substantially perpendicular with respect to a center axis of the first auxiliary rotor.

12. The unmanned aerial vehicle of claim 4, wherein the first housing comprises a payload attachment point configured to receive at least one of a sensor or a power source, and the second housing is configured to receive at least one power source removably coupled thereto.

13. A method for operating an unmanned aerial vehicle, comprising:
positioning a primary shroud in a first orientation with respect to a center body, a primary rotor is mounted to the primary shroud and defines a rotor axis, and the center body at least partially surrounds the primary shroud and defines a center axis; and
rotating the primary shroud with respect to the center body from the first orientation, wherein the rotor axis and the center axis are substantially parallel, to a second orientation, wherein the rotor axis and the center axis are substantially perpendicular.

14. The method of claim 13, further comprising rotating a first auxiliary rotor with respect to the center body from the first orientation to the second orientation.

15. The method of claim 14, further comprising rotating a second auxiliary rotor with respect to the center body from the first orientation to the second orientation.

16. The method of claim 14, wherein rotating the first auxiliary rotor with respect to the center body from the first orientation to the second orientation changes a direction of thrust generated by the first auxiliary rotor.

17. An unmanned aerial vehicle comprising:
a primary shroud;
a primary rotor mounted to the primary shroud and defining a rotor axis; and
a center body at least partially surrounding the primary shroud and defining a center axis, the primary shroud is rotatably coupled to the center body, wherein the primary rotor and the primary shroud are rotatable together between a first orientation with respect to the center body, wherein the rotor axis and the center axis are substantially parallel, and a second orientation with respect to the center body, wherein the rotor axis and the center axis are substantially perpendicular.

18. The unmanned aerial vehicle of claim 17, further comprising a servo motor mounted to the center body, the servo motor is configured to rotate the primary shroud with respect to the center body between the first orientation and the second orientation.

19. The unmanned aerial vehicle of claim 17, wherein the primary rotor is rotatable with respect to the primary shroud about a second axis that is oriented substantially perpendicular with respect to the center axis.

20. The unmanned aerial vehicle of claim 17, further comprising a plurality of auxiliary propulsion units mounted to the center body, wherein each auxiliary propulsion unit is rotatable with respect to the center body.
